(19) United States
(12) Patent Application Publication
(10) Pub. No.: US 2018/0312247 A1
(43) Pub. Date: Nov. 1, 2018

(54) CARRYING DEVICE

(71) Applicant: PRODRONE CO., LTD., Nagoya-shi, Aichi (JP)

(72) Inventor: Kazuo ICHIHARA, Nagoya-shi (JP)

(73) Assignee: PRODRONE CO., LTD., Nagoya-shi, Aichi (JP)

(21) Appl. No.: 15/771,365

(22) PCT Filed: Nov. 4, 2016
(86) PCT No.: PCT/JP2016/082732

§ 371 Date: Apr. 26, 2018

(30) Foreign Application Priority Data
Nov. 6, 2015 (JP) 2015-218703

(51) Int. Cl. B64C 27/08; B64C 1/22

(52) U.S. Cl. CPC B64C 27/08; B64C 39/02; B64C 1/22

(57) ABSTRACT

A carrying device that carries a piece of freight by hanging it from an unmanned aerial vehicle via a flexible member and, in moving the freight toward the ground with the vehicle hovering, confirms the freight has landed, and removes it. The device includes: an unmanned aerial vehicle including a plurality of propellers each drivable into rotation by a motor; a support wire mounted on the vehicle and made of a flexible member configured to support a piece of freight; and a landing detector configured to detect a landing of freight supported on the wire when moved from a space in air toward a ground. The landing detector is preferably configured to detect the landing of the freight based on at least one change in a load acting on the vehicle as a weight, a weight acting on the support wire, and a distance from the freight to the ground.

### TECHNICAL FIELD

The present invention relates to a carrying device. More specifically, the present invention relates to a carrying device capable of carrying freight using an unmanned aerial vehicle having a plurality of propellers.

### BACKGROUND ART

As one method of carrying freight using an aircraft such as a helicopter, known practice is to mount a winch on an outside portion of the aircraft, mount a hook on a lower end of a cable wound around the winch, hang a piece of freight on the hook, and carry the piece of freight. This practice is recited in, for example, patent literature 1, and a possible application of the practice is in disaster relief and similar activities.

Generally, when an article is moved by being hung on a wire using a winch, the amount of winding-out and the amount of winding-up of the wire using the winch are added up to detect a height position of the article. For example, patent literature 2 recites a position detector that is connected to a motor and a wire drum constituting a winch and that detects a current position of a hung object based on the amount of winding-up/amount of winding-out of a wire rope.

In recent years, there has been a rapid rise in popularity of small-size unmanned aerial vehicles (UAVs) represented by industrial unmanned helicopters, especially small-size multi-copters. This has led to attempts to introduce UAVs to a wide range of fields. A multi-copter is an aircraft that is equipped with a plurality of rotors and that flies while maintaining a balance of the airframe by adjusting the number of rotations of each of the rotors. Flight control of a multi-copter, that is, control of posture and position of a multi-copter during a flight can be implemented by remote control or autonomous control.

### CITATION LIST

### Patent Literature

PTL1: JP 2009-73223 A

PTL2: JP H11-79682 A

### SUMMARY OF INVENTION

### Technical Problem

The method recited in patent literature 1, which includes mounting a flexible member such as a wire on an outside portion of an aircraft and carrying a piece of freight by hanging it on the flexible member, can be acting on unmanned aerial vehicles. This may provide a higher level of usefulness in carrying freight than when a conventional typical aircraft such as a helicopter is used. Multi-copters are highly accurate in (hovering) control of hovering at a fixed point; with a multi-copter hovering, the operations mounting and removing freight can be performed easily. In particular, an electrically releasable configuration may be employed in a support tool, such as a hook, that supports a piece of freight at the leading end of a wire. In this case, the support tool is released using remote control or autonomous control, as well as using this control for the flight control of the multi-copter. This ensures that with the multi-copter hovering at the destination of the freight to be carried, the freight can be removed without human intervention.

When a piece of freight is to be removed without the multi-copter landing, especially when a piece of freight is to be removed without human intervention, it is preferable to confirm that the freight has landed before removing the freight, in order to avoid an occurrence such as damage to the freight. However, position coordinates of unmanned aerial vehicles such as multi-copters in a three-dimensional space are freely changeable, and thus a landing of the freight may not necessarily be detected accurately by the method of estimating a height position of a piece of the freight based on the amount of winding-out and the amount of winding-up of the wire on a winch, which is recited in patent literature 2.

A problem to be solved by the present invention is to provide a carrying device that carries a piece of freight by hanging the freight from an unmanned aerial vehicle via a flexible member and that, in moving the freight down toward the ground with the unmanned aerial vehicle hovering, confirms that the freight has landed, and then removes the freight.

### Solution to Problem

In order to solve the above-described problem, the present invention provides a carrying device including: an unmanned aerial vehicle including a plurality of propellers each drivable into rotation by a motor; a support wire mounted on the unmanned aerial vehicle and made of a long-size flexible member configured to support a piece of freight to be carried; and a landing detector configured to detect a landing of the freight supported by the support wire when the freight is moved down from a space in air toward a ground.

The landing detector may be configured to detect the landing of the freight based on at least one change in a load acting on the unmanned aerial vehicle as a weight, a weight acting on the support wire, and a distance from the freight to the ground.

The carrying device may include a winch fixed to the unmanned aerial vehicle and configured to wind up and wind out the support wire. The winch may be configured to, with the unmanned aerial vehicle hovering at a constant altitude, wind out the support wire to move the freight supported by the support wire down from the space in the air toward the ground. The landing detector may be configured to monitor at least one weight parameter selected from a load current of the motor and a number of rotations of each of the propellers, and configured to detect a decrease in the load acting on the unmanned aerial vehicle as the weight when a value of the weight parameter decreases, thereby detecting the landing of the freight.

Alternatively, the landing detector may include a weight detector configured to detect the weight acting on the support wire. The landing detector may be configured to detect the landing of the freight by detecting a decrease in the weight acting on the support wire.

Alternatively, the landing detector may include a distance measuring sensor fixed to the support wire or the freight, and may be configured to compare the distance to the ground detected by the distance measuring sensor with a distance from the distance measuring sensor to a bottom surface of the freight so as to detect the landing of the freight.

The distance measuring sensor may be configured to communicate wirelessly with a controller that controls a flight state of the unmanned aerial vehicle.

The support wire may include a support tool that supports the freight and that is controllable to release a supported state of the freight by a controller that controls a flight state of the unmanned aerial vehicle. The landing detector may be configured to transmit a measurement result to the controller. When the controller receiving the measurement result has detected the landing of the freight, the controller may be configured to release the supported state of the freight supported by the support tool.

### Advantageous Effects of Invention

The carrying device according to the above-described invention includes a landing detector. This ensures that when the freight supported by the support wire is moved down from the space in the air toward the ground, the landing detector is used to confirm that the freight has landed, and then the freight is removed. Thus, a landing of freight is directly detected, instead of estimating a landing of freight using indicators such as coordinates of the unmanned aerial vehicle and the pendent amount of the support wire. This ensures that a landing of freight is accurately confirmed even after the unmanned aerial vehicle made a flight that involved great fluctuations in height position or a flight through a complicated path. Also, even if there are various shapes and/or sizes of freight, a landing of the freight is accurately detected.

The landing detector may detect a landing of a piece of the freight based on at least one change in a load acting on the unmanned aerial vehicle as a weight, a weight acting on the support wire, and a distance from the freight to the ground. Any of these parameters are sensitive to and variable depending on a landing of freight. This enables a landing of freight to be accurately detected.

The carrying device may include a winch fixed to the unmanned aerial vehicle and configured to wind up and wind out the support wire. The winch may, with the unmanned aerial vehicle hovering at a constant altitude, wind out the support wire to move a piece of freight supported by the support wire down from the space in the air toward the ground. The landing detector may monitor at least one weight parameter selected from a load current of the motor and a number of rotations of each of the propellers, and detect a decrease in the load acting on the unmanned aerial vehicle as the weight when a value of the weight parameter decreases, thereby detecting the landing of the freight. In this case, the load acting on the unmanned aerial vehicle as the weight of the freight sharply decreases because of the landing of the freight. This causes a sharp decrease in the load current of the motor and the number of rotations of each of the propellers necessary for the unmanned aerial vehicle to hover at a constant altitude. By detecting this decrease, a landing of freight is accurately detected. In this respect, a measuring device to monitor the load current of the motor and/or the number of rotations of each of the propellers can be added to the unmanned aerial vehicle in a comparatively simple manner. Thus, the landing detector can be implemented with a simple configuration.

Alternatively, the landing detector may include a weight detector to detect the weight acting on the support wire. The landing detector may detect a landing of a piece of freight by detecting a decrease in the weight acting on the support wire. In this case, the weight of the freight acting on the support wire sharply decreases because of the landing of the freight. This enables a landing of freight to be accurately detected.

Alternatively, the landing detector may include a distance measuring sensor fixed to the support wire or a piece of freight, and may compare the distance to the ground detected by the distance measuring sensor with a distance from the distance measuring sensor to a bottom surface of the freight so as to detect the landing of the freight. At the time when the bottom surface of the freight touches the ground, the distance from the position at which the distance measuring sensor is located to the ground is equal to the distance from the position to the bottom surface of the freight. This positional relationship between freight and the ground is directly monitored, which enables a landing of freight to be accurately detected.

The distance measuring sensor may communicate wirelessly with a controller that controls a flight state of the unmanned aerial vehicle. This enables the distance measuring sensor to inform the controller that the freight has landed without the need for providing a communication line having, for example, such a configuration that is superimposed on the support wire. Also, the distance measuring sensor can be fixed to the bottom surface of the freight with a simple configuration. Although it is possible to have wired communication, wireless communication is preferred in an application in which a winch is used, because the distance between the freight and the controller varies depending on the amount of winding-out of the support wire.

The support wire may include a support tool that supports apiece of freight and that is controllable to release a supported state of the freight by a controller that controls a flight state of the unmanned aerial vehicle. The landing detector may transmit a measurement result to the controller. When the controller receiving the measurement result has detected the landing of the freight, the controller may release the supported state of the freight supported by the support tool. This enables the removal of the freight to be completed after it has been confirmed automatically, instead of manually, that the freight has landed.

### BRIEF DESCRIPTION OF DRAWINGS

FIG. 1 is a schematic perspective view of an external appearance of a carrying device according to a first embodiment of the present invention.

FIG. 2 is a block diagram schematically illustrating a control system of the carrying device.

FIG. 3 is a perspective view of the carrying device that is moving a piece of freight down toward the ground.

FIG. 4 is a perspective view of the carrying device with the downward freight landing.

FIG. 5 is a block diagram schematically illustrating a carrying device according to a second embodiment of the present invention.

FIG. 6 is a schematic perspective view of an external appearance of a carrying device according to a third embodiment of the present invention.

FIG. 7 is a block diagram schematically illustrating a control system of the carrying device according to the third embodiment.

FIG. 8 is a perspective view of the carrying device according to each of the embodiments of the present invention illustrating a configuration in which an auxiliary wire is used.

FIG. 9 is a perspective view of a resistance member mountable on the carrying device according to each of the embodiments of the present invention.

### DESCRIPTION OF EMBODIMENTS

A carrying device according to an embodiment of the present invention will be described in detail by referring to the drawings. A carrying device according to an embodiment of the present invention carries a piece of freight to be carried by moving in the air with the freight hung from the carrying device.

### First Embodiment: Detection of Weight Load

### (1) Configuration of Carrier

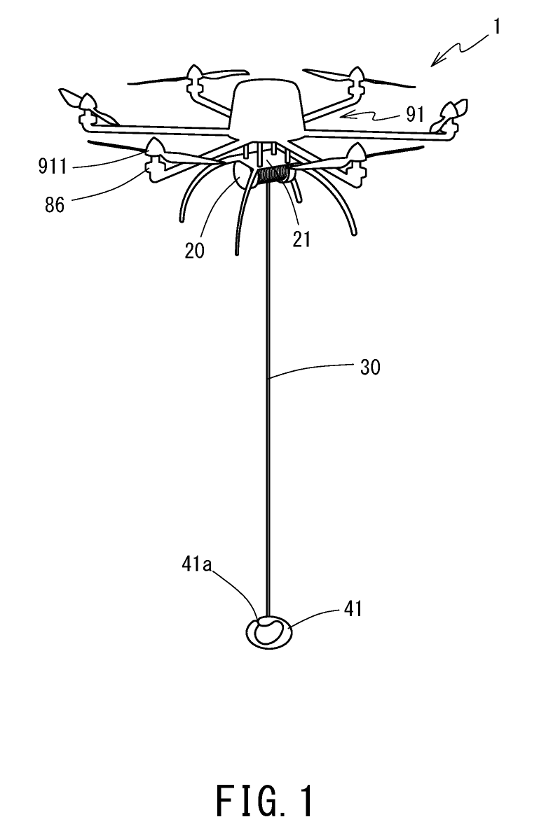

FIG. 1 is a perspective view of an external appearance of a carrying device 1 according to the first embodiment of the present invention. The carrying device 1 mainly includes: a multi-copter 91, which is an unmanned aerial vehicle and includes a plurality of (in this embodiment, six) propellers 911; and a winch (winch) 20, which is fixed to a lower portion of the multi-copter 91 via an adapter plate 21. The carrying device 1 also includes a support wire 30, which is wound around the winch 20 to be wound out and wound up by the winch 20.

The support wire 30 is implemented in the form of a long-size flexible member (string-shaped member), which may be made of any material such as metal material, fiber material, and polymer material. The support wire 30 may have a single-line structure, a stranded-line structure such as a rope, or a structure made up of a plurality of small elements connected together, such as a chain. To the leading end of the support wire 30, a hook-shaped support tool 41 is connected. The support tool 41 is for supporting a piece of freight B. An openable-closable portion 41a of the support tool 41 is openable and closable by manual operation and capable of electrically making an opening operation upon receipt of a control signal.

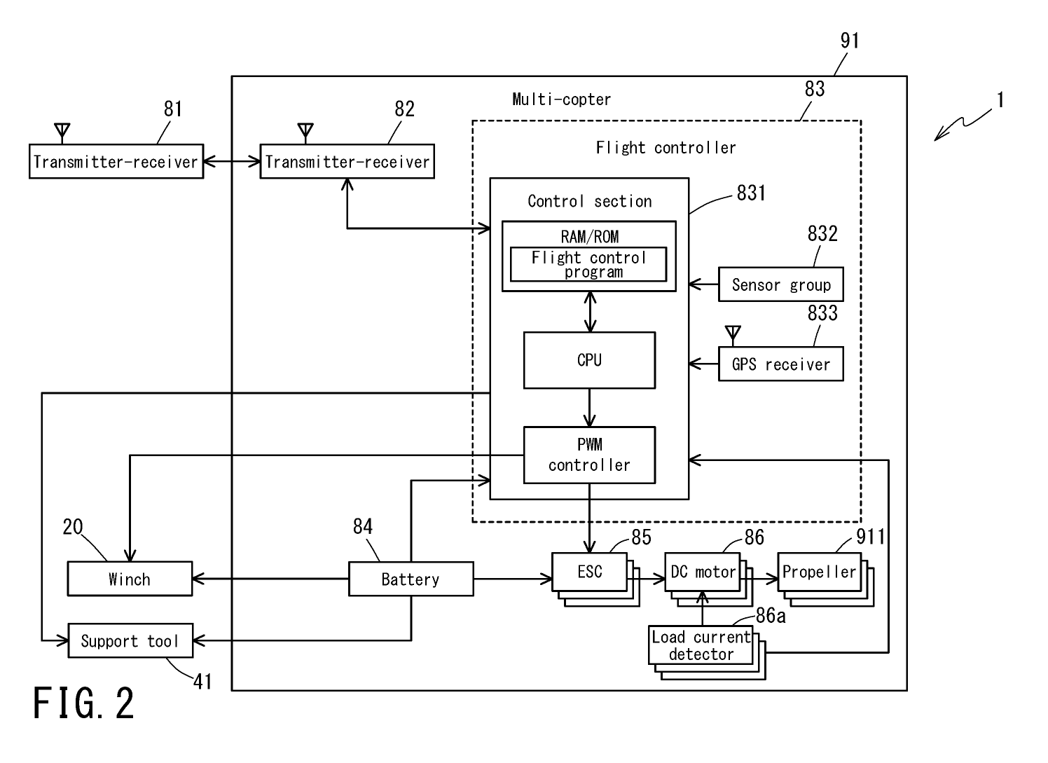

FIG. 2 is a block diagram illustrating a functional configuration of the carrying device 1. The multi-copter 91 mainly includes: a flight controller 83, which controls the posture and flight operation of the multi-copter 91 in the air; the plurality of propellers 911, which rotate to generate lift force of the multi-copter 91; a transmitter-receiver 82, which has wireless communication with an operator (transmitter-receiver 81); and a battery 84, which supplies power to these elements.

The flight controller 83 includes a control section 831, which is a micro-controller. The control section 831 includes: a CPU, which is a central processing unit; a RAM/ROM, which is a storage device; and a PWM controller, which controls rotation of DC motors 86. Each of the DC motors 86 is connected to a corresponding one of the propellers 911, and at a command from the PWM controller, the number of rotations (rotational speed) of each DC motor 86 is controlled via an ESC (Electric Speed Controller) 85. By adjusting a balance between the numbers of rotations of the four propellers 911, the posture and position of the multi-copter 91 are controlled. [0030] To each of the DC motors 86, a load current detector 86a is attached. The load current detector 86a measures the amount of load current supplied from the battery 84 and flowing through each of the DC motors 86. Information of the load current detected by the load current detector 86a is transmitted to the control section 831. The information of the load current input into the control section 831 is used to control the posture and position of the multi-copter 91 in the form of feedback control or in another form, and is also used as a landing detector that detects a landing of the freight B by monitoring weight load.

The flight controller 83 includes a sensor group 832 and a GPS receiver 833, which are connected to the control section 831. The sensor group 832 of the multi-copter 91 includes an acceleration sensor, a gyro sensor (angular velocity sensor), a pneumatic sensor, and a geomagnetic sensor (electronic compass). [0032] The RAM/ROM of the control section 831 stores a flight control program in which a flight control algorithm associated with a flight of the multi-copter 91 is described. Based on information obtained from the sensor group 832, the control section 831 is capable of controlling the posture and position of the multi-copter 91 using the flight control program. In this embodiment, the operator is able to manually perform the flight operation of the multi-copter 91 via the transmitter-receiver 81. Alternatively, the RAM/ROM may store an autonomous flight program in which flight plans such as GPS coordinates, altitude, and flight route are described as parameters so that the multi-copter 91 makes an autonomous flight.

The winch 20 is controlled via the pulse width modulation (PWM) controller of the control section 831 to perform operations of winding-out and winding-up of the support wire 30. A command to cause the winch 20 to perform winding-out and winding-up of the support wire 30 may be made by the operator via the transmitter-receiver 81. Alternatively, the command may be made as one function of the autonomous flight program, that is, made automatically according to the program based on position coordinates or other parameters of the multi-copter 91. The power to drive the winch 20 to perform winding-out and winding-up of the support wire 30 is supplied from the battery 84 of the multi-copter 91.

The hook-shaped support tool 41, which is disposed at the leading end of the support wire 30, is openable and closable at the openable-closable portion 41a by manual operation, as described above. By a control signal from the control section 831, the openable-closable portion 41a in closed state can be turned into open state. Power to cause this opening operation to be performed is supplied from the battery 84. Signal lines and feeding lines via which the support tool 41 is connected to the control section 831 and the battery 84 are superimposed on the support wire 30.

### (2) Schematic of Method of Carrying Freight

When the freight B is carried using the carrying device 1, the freight B is first mounted on the carrying device 1 at a predetermined freight mounting point. Before mounting the freight B on the carrying device 1, it is necessary to form, on the freight B, a supported structure that can be supported by the support tool 41. For example, when the support tool 41 is hook-shaped, as in this embodiment, it is possible to use a loop structure such that a string-shaped member such as a webbing sling B1 is wound around the freight B, and the string-shaped member is hung on the hook of the support tool 41 in a point-hanging manner (one-point hanging or multi-point hanging, preferably multi-point hanging).

Thus, the freight B is supported by the support tool 41 using the supported structure, and the freight B is mounted on the leading end of the support wire 30. In this respect, the multi-copter 91 may be kept waiting on a ground G while the freight B is being mounted, and then the multi-copter 91 may start a flight. Alternatively, the carrying device 1 without the freight B mounted thereon may be moved in the air to a position over the freight mounting point, and the mounting of the freight B may be performed from the ground G with the multi-copter 91 kept hovering (hovering) at a fixed position in the air over the freight mounting position. In this case, with the multi-copter 91 hovering, the control section 831 drives the winch 20 to wind out the support wire 30 to a height position at which the freight B placed on the ground G can be mounted on the support tool 41. With the support wire 30 in this state, a worker operates the support tool 41 from the ground G to, for example, hang the loop of the supported structure on the support tool 41, thereby mounting the freight B placed on the ground G on the support tool 41. After the mounting of the freight B, the openable-closable portion 41a of the support tool 41 is turned into closed state. It is noted that in this specification, the fixed position at which the multi-copter 91 hovers may have a degree of tolerance that will not affect the mounting and removal of the freight B.

When the worker has completed the work of mounting the freight B, the control section 831 drives the winch 20 to wind up the support wire 30. This causes the freight B supported on the leading end of the support wire 30 to be lifted up in the air. The winding-up of the support wire 30 is performed until the pendent amount of the support wire 30 becomes approximately zero. Thus, when the freight B is turned into a state of being hung immediately under the winch 20, the multi-copter 91 stops hovering and makes a flight to move to the destination to which the freight B is to be carried.

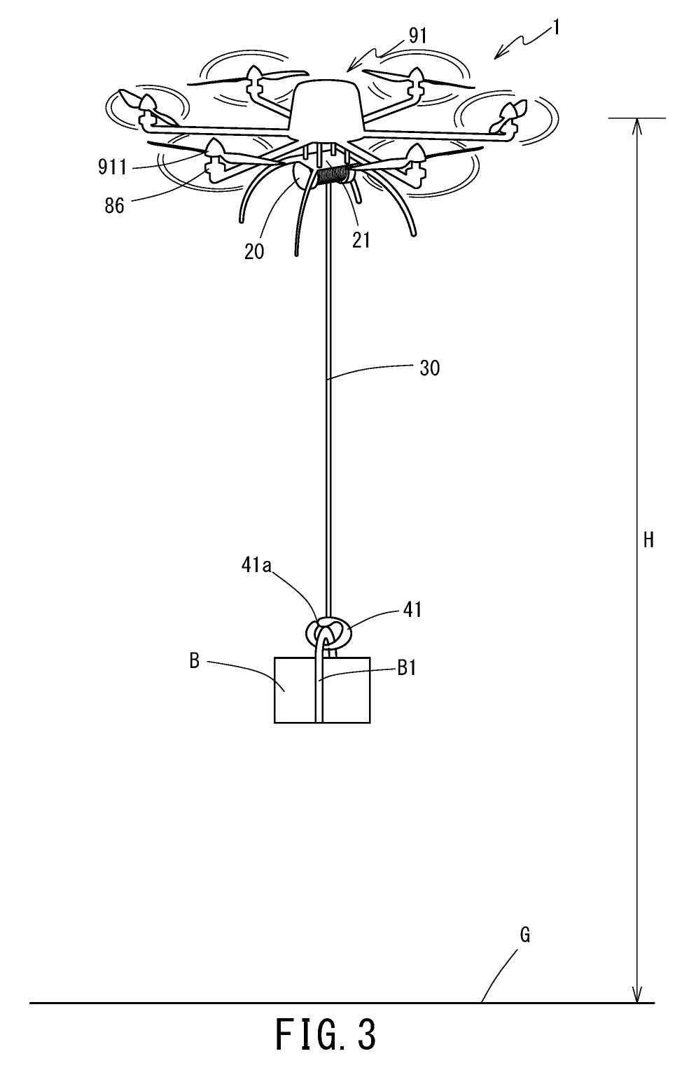

When the carrying device 1 has reached the destination, the control section 831 starts a freight removing step in response to a command transmitted from the operator via the transmitter-receiver 81 or in response to the autonomous flight program stored in the control section 831. In the freight removing step, the multi-copter 91 is controlled to hover. Then, the control section 831 drives the winch 20 to wind out the support wire 30 downward. This causes, as illustrated in FIG. 3, the freight B supported on the support wire 30 to be moved down from the space in the air toward the ground G. The winding-out of the support wire 30 is performed until a landing of the freight B on the ground G is detected, as described in detail later.

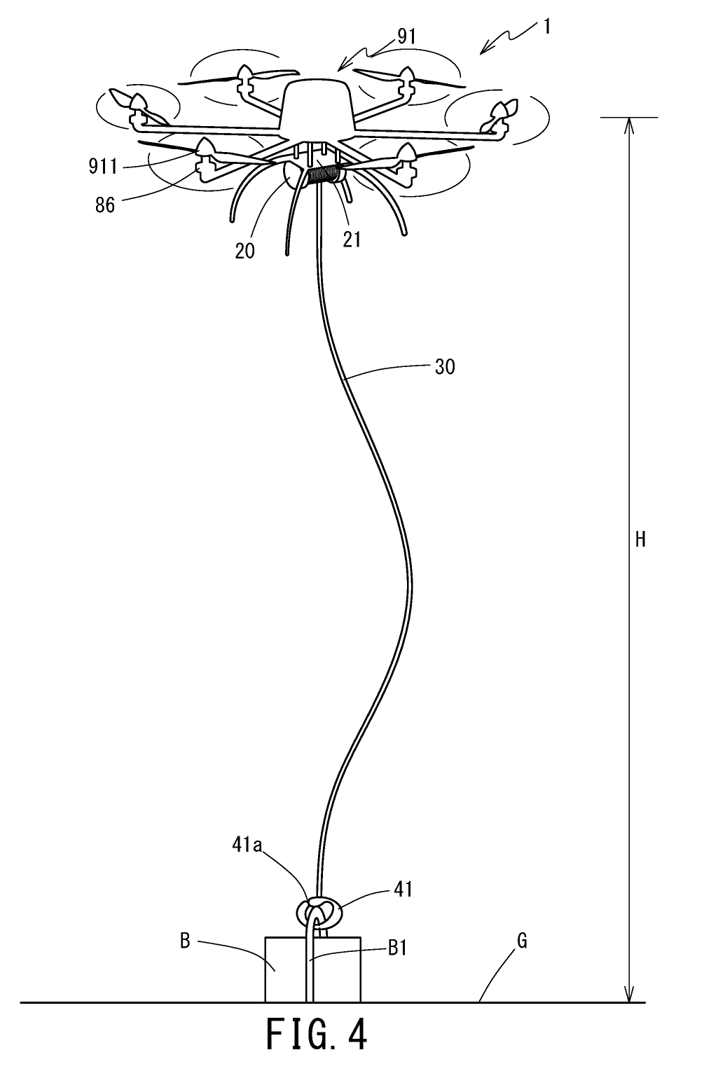

When the freight B has landed as illustrated in FIG. 4 and the landing is detected by the control section 831, the winding-out of the support wire 30 performed by the winch 20 is stopped. Then, a command from the control section 831 turns the openable-closable portion 41a of the support tool 41 into open state. This causes the support tool 41's support of the freight B to be released, making the freight B removed from the support wire 30. It is noted that the winding-out of the support wire 30 is stopped preferably not immediately after the landing of the freight B on the ground G is detected, which is when the support wire 30 is tensioned. Rather, from the viewpoint of stable release of the support tool 41's support, the winding-out of the support wire 30 is preferably stopped as illustrated in FIG. 4, where the winding-out of the support wire 30 is continued for some period of time after the landing of the freight B on the ground G was detected, and then the winding-out of the support wire 30 is stopped so that the support wire 30 is kept loose.

The freight removing step described here is caused to start by a command from the operator or according to the autonomous flight program. Once the freight removing step starts, it proceeds automatically, without the need for the operator's manual work. When the removal of the freight B has completed, the winch 20 winds up the support wire 30, and the carrying device 1 makes a flight to another place, as necessary.

### (3) Detection of Landing of Freight

As described above, in the freight removing step, the winch 20 winds out the support wire 30 to move the freight B down from the space in the air toward the ground G. In this respect, the control section 831 detects that the freight B has landed, and the control section 831 stops the winding-out of the support wire 30. Then, the control section 831 makes a command for release of the support tool 41's support of the freight B. The detection of the landing of the freight B, which prompts these operations, is performed by a landing detector whose functions are implemented by the load current detector 86a, which is disposed in the DC motor 86, and the control section 831.

As illustrated in FIG. 3, while the freight B is hung on the multi-copter 91 via the support wire 30 with the multi-copter 91 hovering at a predetermined height H, it is necessary to support all the weight of the freight B by the multi-copter 91. In order to generate a lift force to maintain the height H with the weight supported, it is necessary for the propellers 911 to rotate at high speed, as indicated by imaginary lines in FIG. 3. For this purpose, a large amount of load current flows through each of the DC motors 86.

With the state illustrated in FIG. 3, when the winch 20 winds out the support wire 30, the freight B contacts the ground G, as illustrated in FIG. 4. Thus, the freight B lands. After the freight B lands, the weight of the freight B is supported by the ground G, and thus the multi-copter 91 need not support the weight of the freight B any more. As indicated by imaginary lines in FIG. 4, this decreases the number of rotations of the propellers 911 necessary to maintain the hovering at the height H, which is the height of hovering before the freight B landed. As a result, the amount of load current flowing through each of the DC motors 86 decreases.

Thus, in flight control to maintain a hovering at the height H, when the freight B lands, the load current detector 86a detects the landing, causing a sharp decrease in the amount of load current flowing through each of the DC motors 86. The amount of load current is monitored by the control section 831. Upon detection of the sharp decrease in the amount of load current, the control section 831 detects a discontinuous decrease in the load (weight load) acting on the multi-copter 91 as a weight, that is, detects a landing of the freight B.

A landing of the freight B is sensitively reflected as a discontinuous decrease in the weight load on the multi-copter 91. Further, in the multi-copter 91 under hovering control, a change in the weight load is sensitively reflected in a change in the amount of load current of the DC motor 86. By using the amount of load current of the DC motor 86 as an indicator, a landing of the freight B is detected with a high level of accuracy. In this embodiment, the DC motor 86 is provided with the load current detector 86a, and the load current flowing through the DC motor 86 is monitored as an indicator of the weight load on the multi-copter 91. Instead, it is possible to provide the propellers 911 with a rotation number detector to detect the number of rotations, which may be monitored by the control section 831 as an indicator of the weight load on the multi-copter 91. In this case, by detecting a sharp decrease in the number of rotations of the propellers 911, a landing of the freight B is detected. That is, at least one weight parameter selected from the amount of load current of the DC motor 86 and the number of rotations of the propellers 911 may be monitored as a weight parameter in which the weight load on the multi-copter 91 is reflected, and a sharp decrease in the value of the weight parameter may be considered as a detection of a landing of the freight B.

Thus, a landing of the freight B is directly confirmed by the landing detector, and then the winding-out of the support wire 30 from the winch 20 is stopped, so that the support tool 41's support of the freight B is released. This ensures safe removal of the freight B, without making an impact on the freight B. In the carrying device 1, which is freely movable in a three-dimensional space using the multi-copter 91, there are two coexisting ways of changing the height position of the freight B: changing position coordinates of the multi-copter 91; and changing the amount of winding-out of the support wire 30 from the winch 20. However, instead of using position coordinates of the multi-copter 91 or the amount of winding-out of the support wire 30 as a basis of calculating the height position of the freight B so as to assume a landing, a landing of the freight B may be directly detected by the landing detector. This ensures a more accurate landing of the freight B, even if position coordinates of the multi-copter 91 change greatly and in a complicated manner.

The support tool 41's support of the freight B may be released manually by the operator on the ground G, instead of using a control signal from the control section 831. In this case as well, the effect of safe removal of the freight B is obtained by confirming a landing of the freight B using the landing detector. However, when the support tool 41's support of the freight B is released without human intervention, as in this embodiment, use of the landing detector ensures that after making a command to start a winding-out operation of the support wire 30 supporting the freight B from the winch 20, the entire control through to finish of the removal of the freight B is performed automatically and safely.

The load current detector 86a, which detects the amount of load current of the DC motor 86, and the rotation number detector, which detects the number of rotations of the propellers 911, can be added comparatively simply to general multi-copters that do not detect a landing of the freight B, and also can be used, for example, in control of posture and/or position of multi-copters using feedback control or other control. Thus, a landing detector to detect a landing of the freight B can be implemented simply using a configuration of a conventional general multi-copter by monitoring a weight parameter, as in this embodiment. As a result, in the carrying device 1, which uses the multi-copter 91, a landing detector can be implemented while avoiding a complicated configuration and an increase in weight.

### Second Embodiment: Detection of Weight on Support Wire

The configuration of the landing detector to detect a landing of the freight B can be implemented in various other manners than using the weight load on the multi-copter 91 as an indicator, as described in the first embodiment. Here, a method of using the weight on the support wire 30 as an indicator will briefly be described as a second embodiment of the present invention. In the following description of the second embodiment, the third embodiment, and the fourth embodiment, configurations identical to those in the first embodiment will not be elaborated, with only different configurations being described.

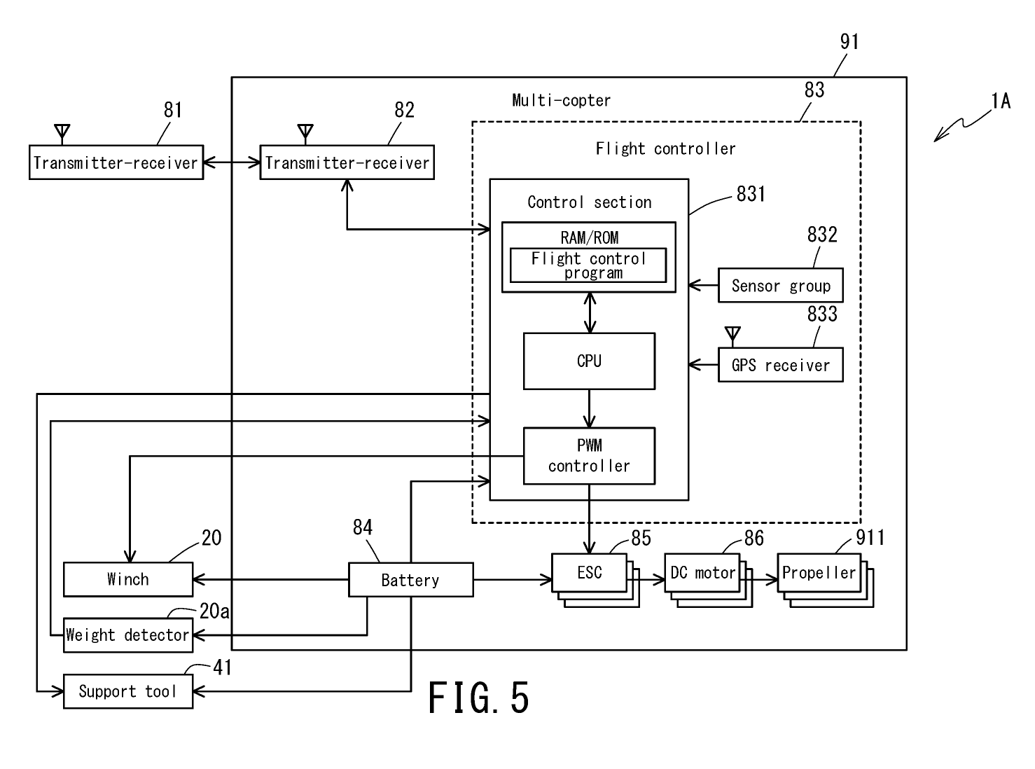

FIG. 5 is a block diagram illustrating a configuration of a carrying device 1A according to the second embodiment of the present invention. Here, a weight detector 20a is provided. The weight detector 20a may be mounted on the winch 20 and measure a weight acting on the base end (a point at which the support wire 30 wound around the winch 20 is away from the circumference of the winch 20) of the support wire 30 that is pendent from the space in the air toward the ground G. Information of the weight measured by the weight detector 20a is transmitted to and monitored by the control section 831. Power of the weight detector 20a is supplied from the battery 84.

In the state in which the support wire 30 is pendent and the multi-copter 91 is hovering in the air with the freight B hung on the leading end of the support wire 30, the support wire 30 is tensioned by the weight of the freight B, causing a large amount of weight acting on the base end of the support wire 30 (see FIG. 3). In contrast, when the support wire 30 is further wound out and the freight B lands by contacting the ground G, the weight of the freight B is supported by the ground G, releasing the tension on the support wire 30. This causes a sharp decrease in the weight acting on the base end of the support wire 30 (see FIG. 4). That is, with the winding-out of the support wire 30 performed by the winch 20, a sharp decrease in the weight measured by the weight detector 20a is detected. This enables a landing of the freight B to be to be detected.

Thus, by implementing a landing detector using the weight detector 20a, a landing of the freight B is detected with a high level of accuracy using the phenomenon that the weight of the freight B is suddenly supported by the ground G upon landing of the freight B, similarly to implementing a landing detector by monitoring weight load in the first embodiment. It is noted, however, that when the weight detector 20a is used, a change in the altitude of the multi-copter 91 before and after landing of the freight B also causes the landing of the freight B to be reflected in a change in the weight on the support wire 30. Therefore, instead of moving the freight B downward by the winding-out of the support wire 30 performed by the winch 20, the altitude of the multi-copter 91 may be lowered, and this enables a landing to be detected in a similar manner. The winch 20 may not essentially be provided; in such cases as where the support wire 30 is comparatively short, the winch 20 may be omitted and the base end of the support wire 30 may be directly fixed to the multi-copter 91. In this case, monitoring of the weight acting on the support wire 30 may be suitably used to detect a landing. It is noted that a change in the weight acting on the support wire 30 may be monitored by other than directly measuring the weight acting on the support wire 30 using the weight detector 20a; it is possible to provide the winch 20 with a tension detector to measure tension acting on the base end of the support wire 30. The tension acting on the support wire 30 is closely related to the weight; by detecting a sharp decrease in the tension, a landing of the freight B can be detected.

### Third Embodiment: Detection of Distance to Ground

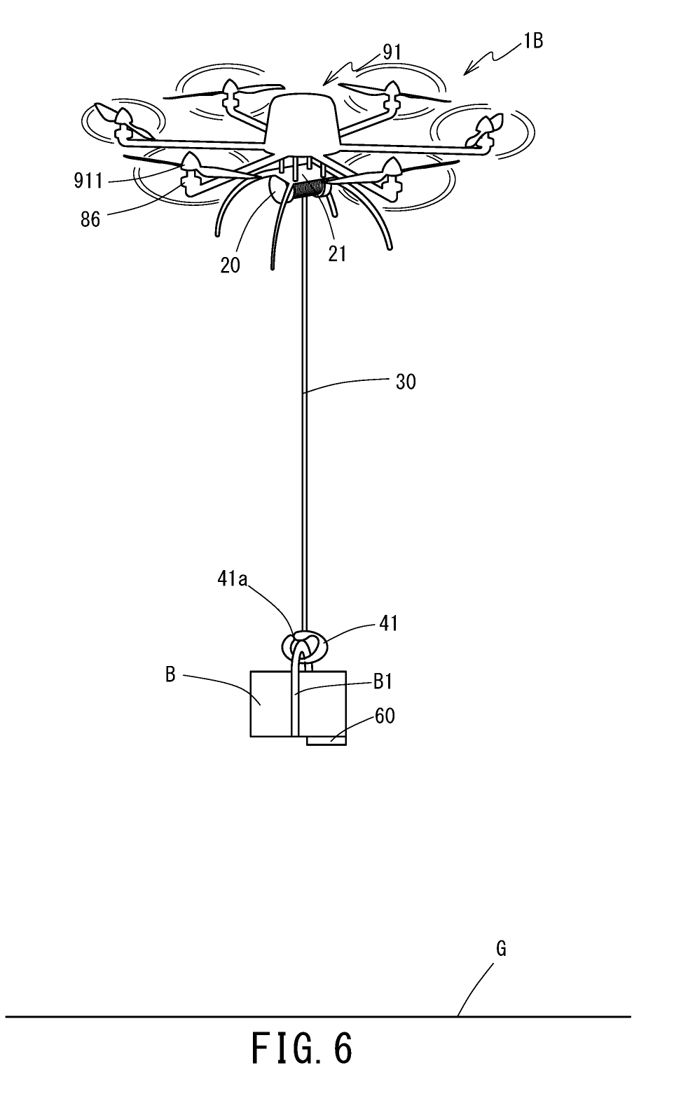

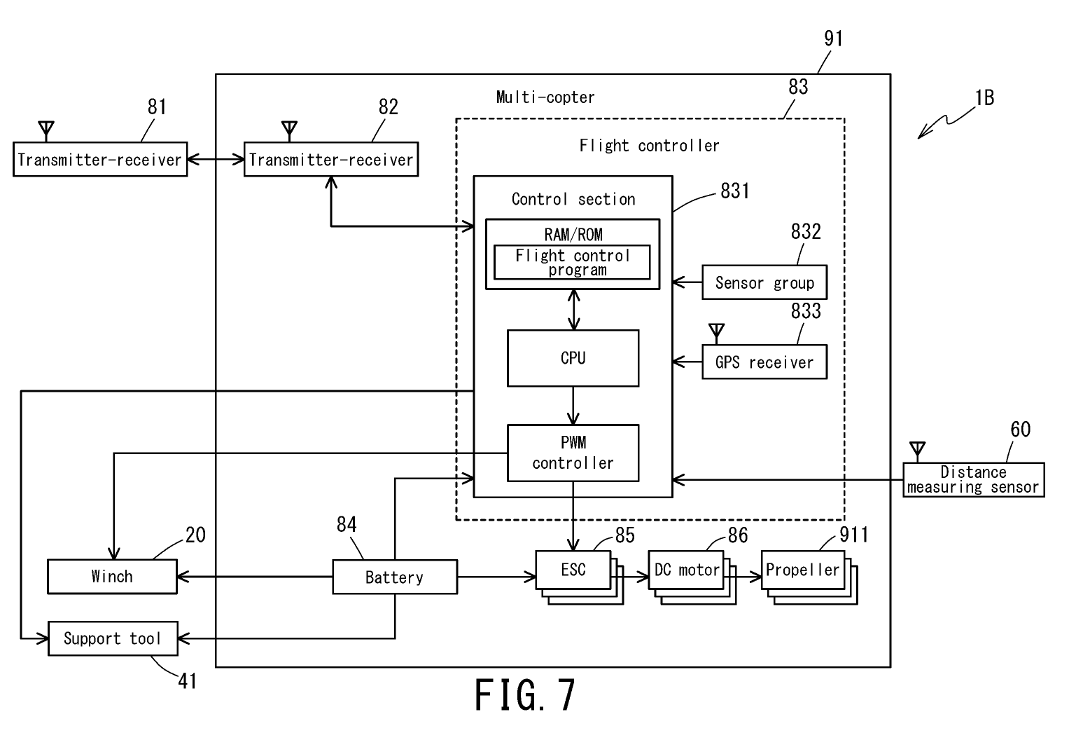

Next, a configuration in which the distance from the freight B to the ground G is used as an indicator will be described as still another configuration of the landing detector. A carrying device 1B according to the third embodiment of the present invention is illustrated in FIG. 6, which is a perspective view of an external appearance of the carrying device 1B, and in FIG. 7, which is a block diagram of the carrying device 1B.

In the carrying device 1B, a distance measuring sensor (distance measuring sensor) 60 is attached to the bottom surface of the freight B, and the distance from the distance measuring sensor 60 to the ground G is measured. As the distance measuring sensor 60, a known distance measuring sensor may be used, such as one utilizing laser. Here, the distance measuring sensor 60 includes a feeding cell, and communicates wirelessly with the control section 831 to transmit information of the measured distance to the ground G to the control section 831. Also, the distance measuring sensor 60 has a shape thin enough to avoid being an obstacle to a stable landing of the freight B.

While the freight B supported on the support wire 30 is being moved down by the winch 20 toward the ground G, the distance to the ground G measured by the distance measuring sensor 60 becomes continuously smaller. Then, upon landing of the freight B, the distance becomes zero. No matter how further the support wire 30 is wound out by the winch 20 and the support wire 30 is thus made loose, the measured distance remains unchanged from zero. Thus, the control section 831 detects such a behavior that the distance to the ground G measured by the distance measuring sensor 60 gradually becomes smaller, and then the distance stops changing from zero. In this manner, the control section 831 detects a landing of the freight B. It is noted that many popular, inexpensive distance measuring sensors are not capable of detecting a distance at zero. In this case, the distance measuring sensor 60 may be disposed at a position that is above the bottom surface of the freight B by a shortest detectable distance, and the zero distance may be read as the shortest detectable distance.

Thus, the configuration in which a landing of the freight B is detected using the distance from the freight B to the ground G as an indicator is similar to the second embodiment, in which the weight on the support wire 30 is used as an indicator, in that a landing can be detected not only when the freight B is moved downward by the winding-out of the support wire 30 performed by the winch 20 but also when the freight B is moved downward by lowering the altitude of the multi-copter 91. In view of simplicity and lightness in weight of the configuration of the landing detector, the configuration in which the distance measuring sensor 60 according to this embodiment is used is superior to the case where the weight detector according to the second embodiment is used.

The position at which the distance measuring sensor 60 is disposed will not be limited to the bottom surface of the freight B; the distance measuring sensor 60 may be disposed at the freight B itself or any other position around the freight B. Then, by comparing the distance to the ground G measured by the distance measuring sensor 60 with the distance from the distance measuring sensor 60 to the bottom surface of the freight B, a landing of the freight B is detected. For example, when the distance from the distance measuring sensor 60 to the ground G becomes equal to the distance to the bottom surface of the freight B, this may be considered as a detection of a landing of the freight B. An example of the position of the distance measuring sensor 60 around the freight B is a position on the support wire 30, in particular, a leading end portion of the support wire 30, which is where the support tool 41 is disposed. In this case, in order for the distance measuring sensor 60 to measure the distance to the ground G without being interfered with by the freight B, the distance measuring sensor 60 protrudes outward from the axis of the support wire 30 beyond the freight B. When the distance measuring sensor 60 is disposed on the support wire 30, if the winch 20 continues winding out the support wire 30 after the freight B has landed, the distance to the ground G measured by the distance measuring sensor 60 becomes equal to the distance from the distance measuring sensor 60 to the bottom surface of the freight B, and then further becomes smaller than this distance. Thus, although there is no particular limitation to the position at which the distance measuring sensor 60 is mounted, the distance measuring sensor 60 may be mounted on the freight B itself, as illustrated in FIG. 6. This ensures that a landing of the freight B is more accurately detected by detecting such a phenomenon that the distance measured by the distance measuring sensor 60 stops changing, remaining constant. It is not necessary to calculate or measure in advance the length between the distance measuring sensor 60 and the bottom surface of the freight B. This simplifies the operation of detecting a landing. In particular, when the distance measuring sensor is fixed to the bottom surface of the freight B, a landing of the bottom surface portion is detected without being affected by a change in shape, dimension, and, in particular, height of the freight B. In contrast, when the distance measuring sensor 60 is mounted on an element of the carrying device 1B, such as the support wire 30, the distance measuring sensor 60 need not be mounted or removed every time the freight is mounted or removed.

In this embodiment, the distance to the ground G is continually monitored using the distance measuring sensor 60. This ensures that not only the simple information of whether the freight B has landed but also information of change in the distance to the ground G before landing can be used to control the multi-copter 91 and the winch 20. For example, in order to protect the freight B from a landing impact, it is possible to control the multi-copter 91 or the winch 20 to lower the speed at which to move the freight B downward immediately before the freight B reaches the ground G, for example, when the freight B has reached a height of approximately 10 centimeters from the ground G. It is noted, however, that many typical, inexpensive winches are not capable of controlling the speed at which to wind out the support wire 30, and that it is preferable to perform control of gently moving the airframe of the multi-copter 91 upward. For example, the airframe of the multi-copter 91 may be moved upward at a speed equal to or lower than the speed at which the freight B is moved downward by the winding-out of the support wire 30 performed by the winch 20. This enables the freight B to land gently.

In the above-described configuration, the distance measuring sensor 60 includes a cell and communicates wirelessly with the control section 831. This configuration, however, is not intended in a limiting sense; the distance measuring sensor 60 may be fed power from the battery 84 to have wired communication with the control section 831. In this case, feeding lines and signal lines through which the distance measuring sensor 60 is connected to the battery 84 and the control section 831 are superimposed on the support wire 30. However, as described above, use of the cell-operated distance measuring sensor 60, which is capable of making wireless communication, facilitates the mounting of the distance measuring sensor 60 on the bottom surface of the freight B, as illustrated in FIG. 6. This configuration also prevents a complicated configuration and an increase in cost involved in the wiring of the feeding lines and the signal lines.

### Fourth Embodiment: Detection of Contact with Ground

Lastly, a configuration in which a contact with the ground G is mechanically detected will briefly be described as still another configuration of the landing detector.

Here, a contact detecting material is mounted on the freight B. The contact detecting material is a member that detects a contact of itself with the ground G and that transmits the contact to the control section 831. As a specific contact detector, it is possible to use a pressure sensor, an acceleration sensor, a capacitance sensor, or any other contact detecting sensor capable of mechanically detecting a contact of the sensor with an object.

The contact detecting sensor may be directly mounted on a lower surface of the freight B. Preferably, a downward-protruding leg member may be disposed on the bottom surface of the freight B, and the contact detecting sensor may be mounted on the leading end of the leg member. In this case, the leg member reaches the ground G before the freight B reaches the ground G. This ensures that a reaching of the freight B to the ground G is detected immediately before the reaching. Also in this case, the leg member also functions as a buffer member that reduces a landing impact of the freight B. In light of this, the structure and material of the leg member may be such that the leg member is able to land stably on the ground G while supporting the freight B and to maintain this state.

### [Other Configurations]

In the carrying device 1 (or 1A to 1C) according to each of the above-described embodiments, the following configurations may be added as modifications. The above-described landing detector is for stabilizing the downward movement and removal of a carried freight B. The following two configurations are for stabilizing the mounting of a freight B to be carried. In order to smoothen the progress of the entire process of carrying the freight B, it is important to also stabilize the mounting of the freight B.

### (1) Addition of Auxiliary Wire

In the carrying device 1 (or 1A to 1C) according to each of the above-described embodiments, in performing a step such as the freight mounting step of mounting the freight B on the support wire 30 pendent from the multi-copter 91 that is hovering, the worker on the ground G operates the support tool 41, which is at the leading end of the support wire 30, to mount the freight B placed on the ground G. During this work, if the support wire 30 is pulled by the worker, the resulting force is transmitted to the multi-copter 91 via the support wire 30. This may instabilize the posture of the multi-copter 91.

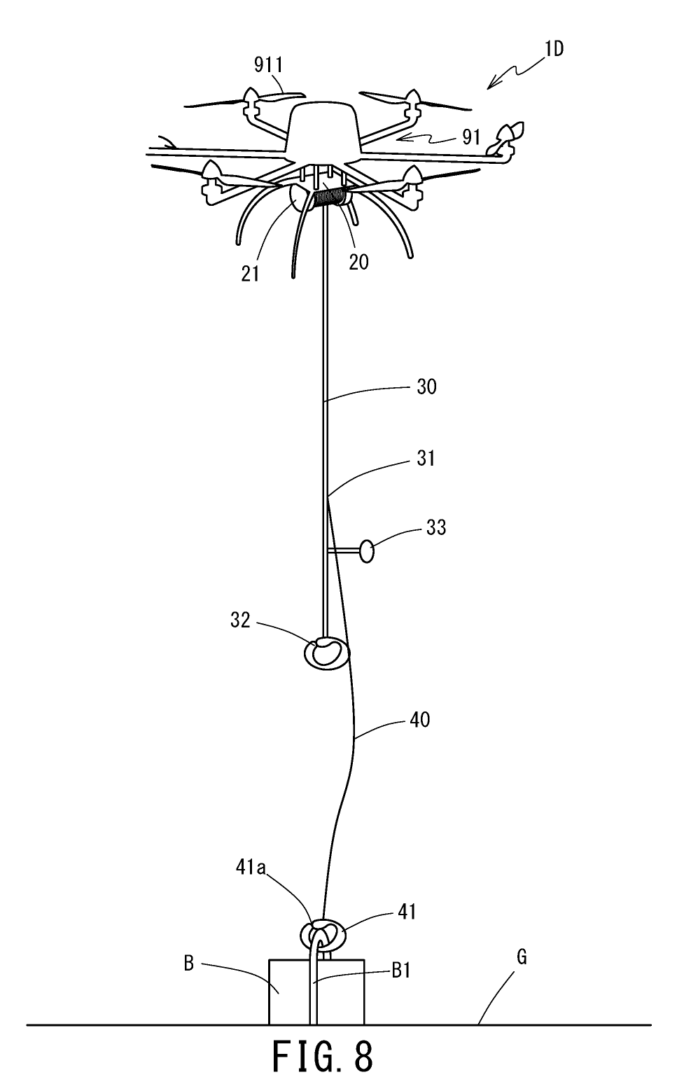

In order to avoid transmission of force to the multi-copter 91 involved in the work of mounting the freight B, an auxiliary wire 40 may be branched from a connection point 31, which is disposed at a position along the support wire 30, as in a carrying device 1D illustrated in FIG. 8. Then, with the auxiliary wire 40 pendent along a longitudinal direction of the support wire 30, the length of the auxiliary wire 40 may be set to extend outward (downward) beyond the leading end of the support wire 30.

While the auxiliary wire 40 may be made of a flexible member identical to the support wire 30, the auxiliary wire 40 may preferably be higher in flexibility than the support wire 30. A difference in flexibility may be implemented by, for example, making the auxiliary wire 40 thinner than the support wire 30 and/or by forming the auxiliary wire 40 from a material lower in rigidity than the support wire 30. Instead of or in addition to the auxiliary wire 40 being higher in flexibility than the support wire 30, the auxiliary wire 40 may be higher in elasticity than the support wire 30.

Here, the support tool 41 is disposed at the leading end of the auxiliary wire 40, instead of being disposed at the leading end of the support wire 30. It is noted, however, that a similar extra support tool 32 may be disposed at the leading end of the support wire 30, as necessary. At a position along the support wire 30, a pin-shaped engagement tool 33 may be disposed so that while the auxiliary wire 40 is not in use, the auxiliary wire 40 can be folded and engaged with the support wire 30.

In the mounting of the freight B, the multi-copter 91 hovers, causing the support wire 30 wound around the winch 20 together with the auxiliary wire 40 to be wound out from the winch 20 into pendent state. In this respect, the amount of winding-out of the support wire 30 is specified such that with the extra support tool 32, which is disposed at the leading end of the support wire 30, not contacting the ground G and with the leading end of the auxiliary wire 40 pendent, the freight B placed on the ground G can be supported by the support tool 41, which is at the leading end of the auxiliary wire 40, without tension on the auxiliary wire 40. When the winding-out of the support wire 30 is stopped at this amount of winding-out, the worker performs work of mounting the freight B on the support tool 41. During this work, the freight B is kept being placed on the ground G. In this respect, since the amount of winding-out of the support wire 30 from the winch 20 is specified in the above-described manner, the auxiliary wire 40 is not tensioned but is kept in loose state. During this mounting work, the worker preferably keeps the auxiliary wire 40 from being tensioned but keeps the auxiliary wire 40 in loose state, as in the state illustrated in FIG. 8.

Thus, the auxiliary wire 40 is provided, which extends downward beyond the support wire 30, and the support tool 41, which supports the freight B, is provided at the side of the auxiliary wire 40. With this configuration, the work of mounting the freight B is performed without tension on the auxiliary wire 40. This ensures that the looseness of the auxiliary wire 40 provides allowance to the mounting work, facilitating the work of mounting the freight B without the need for the worker to pull the auxiliary wire 40. Further, even if a slight amount of force may act on some portion near the leading end of the auxiliary wire 40, this force is absorbed by the looseness of the auxiliary wire 40 and thus becomes difficult to be transmitted to the support wire 30. Thus, force acting on the auxiliary wire 40 is difficult to be transmitted to the multi-copter 91 via the auxiliary wire 40 and/or the winch 20. As a result, during the mounting work as well, the hovering multi-copter 91 is maintained at a stable posture, making the progress of the mounting work smooth and preventing an excessive load from acting on the multi-copter 91. In particular, when the auxiliary wire 40 is higher in flexibility and/or elasticity than the support wire 30, this enhances the effect of facilitating the mounting of the freight B performed by the worker and the effect of making force on the auxiliary wire 40 difficult to be transmitted to the support wire 30. It is noted that the extra support tool 32, which is at the leading end of the support wire 30, may be used to mount a large mass of freight B when this freight B is mounted on the multi-copter 91 in landing state and then the multi-copter 91 takes off. This is because the freight B is held more stably during take-off than when the freight B is mounted on the support tool 41, which is disposed at the leading end of the auxiliary wire 40, which has a free end extending beyond the support wire 30 and has high flexibility and elasticity.

### (2) Addition of Resistance Member

In the carrying device 1 (or 1A to 1D) according to each of the above-described embodiments, in performing a step such as the freight mounting step with the multi-copter 91 hovering, if the support wire 30 is wound out downward without the freight B hung on the support wire 30, the support wire 30 may be caused to swing under the influence of air resistance, natural air, and/or air generated by the propellers 911 of the hovering multi-copter 91. This may prevent the support wire 30 from being wound out stably. Although mounting an anchor on the leading end of the support wire 30 would prevent the swing movement, from the viewpoint of minimized load on the multi-copter 91, lightness in weight of the multi-copter 91 and its accessory members is an important issue. Therefore, mounting an anchor is not realistic.

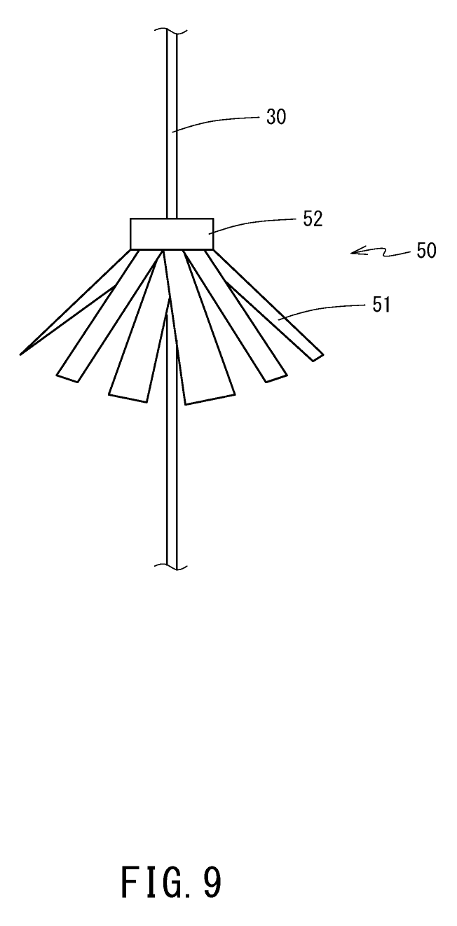

In light of the circumstances, it is possible to provide a resistance member 50 at a position along the support wire 30, as illustrated in FIG. 9. The resistance member 50 is made of a material having a degree of hardness that is not deformed by air caused by the propellers 911 of the multi-copter 91. The resistance member 50 includes: a fixed portion 52, which is fixed to the support wire 30; and a plurality of wing members 51. Each of the wing members 51 has such a surface shape that each wing member 51 is fixed at one end to the fixed portion 52 and extends toward the leading end of the support wire 30 (downward) and away from the axis of the support wire 30. Also, the surface of each wing member 51 does not extend radially relative to the axis of the support wire 30, but has such an inclined surface structure that the angle relative to the axis of the support wire 30 gradually changes from the upper end of each wing member 51 fixed to the fixed portion 52 toward the extending lower end of each wing member 51.

In a region below the hovering multi-copter 91, the propellers 911 cause downward air. When the resistance member 50 receives this downward air, air resistance occurs and provides the support wire 30 with tension directed from the base end of the support wire 30 toward the leading end of the support wire 30. This tension prevents the support wire 30 from swinging and enables the winch 20 to stably wind out the support wire 30 downward.

The air generated downward from the multi-copter 91 is swirling. In light of this, the resistance member 50 is implemented in the form of a plurality of wing members 51, in which there are gaps between the wing members 51, instead of having an integrated, continuous shape like an umbrella. In particular, each of the wing members 51 has an inclined surface structure, as described above. This ensures that no matter how complicated the swirling air becomes, the support wire 30 is stably provided with downward tension without increasing the mass of the wire portion. From the viewpoint of greatest possible stability of the pendent state of the pendent support wire 30 throughout the longitudinal direction of the pendent support wire 30, the resistance member 50 is preferably disposed at a position adjacent to the leading end of the wire 30. However, if the resistance member 50 is disposed at a position too far away from the multi-copter 91, the air amount of downward air from the propellers 911 decreases, diminishing the effect of causing air resistance to occur. An exemplary mounting position where the pendent state of the support wire 30 is stable over as long a region of the support wire 30 as possible while the resistance member 50 receives a sufficient amount of air from the propellers 911 is such that, when the above-described auxiliary wire 40 is provided, the resistance member 50 is disposed at a position adjacent to and above the connection point 31, at which the auxiliary wire 40 branches.

While in the configuration described here the fixed portion 52 of the resistance member 50 is fixed to the support wire 30, it is also possible to mount the fixed portion 52 rotatably about the axis of the support wire 30 so that the resistance member 50 as a whole is rotatable about the support wire 30 with some degree of inertia force. This provides the support wire 30 with a higher level of stability in swirling air situations. Further, the shape of the resistance member 50 will not be limited to the wing members 51, which extend downward; any other shape is possible insofar as the shape receives air generated downward from the multi-copter 91 and thus provides the support wire 30 with downward tension.

An embodiment of the present invention has been described hereinbefore. The present invention, however, will not be limited to the above-described embodiment but may have various modifications without departing from the scope of the present invention.

1-7. (canceled)

8. A carrying device comprising:
an unmanned aerial vehicle comprising a plurality of propellers each drivable into rotation by a motor;
a support wire mounted on the unmanned aerial vehicle and comprising a long-size flexible member configured to support a piece of freight to be carried;
a landing detector configured to detect a landing of the freight supported by the support wire when the freight is moved down from a space in air toward a ground; and
a winch fixed to the unmanned aerial vehicle and configured to wind up and wind out the support wire, the winch being configured to, with the unmanned aerial vehicle hovering at a constant altitude, wind out the support wire to move the freight supported by the support wire down from the space in the air toward the ground,
wherein the landing detector is configured to monitor at least one weight parameter selected from a load current of the motor and a number of rotations of each of the propellers, and configured to detect a decrease in the load acting on the unmanned aerial vehicle as the weight when a value of the weight parameter decreases, thereby detecting the landing of the freight.

9. The carrying device according to claim 8,
wherein the support wire comprises a support tool that supports the freight and that is controllable to release a supported state of the freight by a controller that controls a flight state of the unmanned aerial vehicle,
wherein the landing detector is configured to transmit a measurement result to the controller, and
wherein when the controller receiving the measurement result detects the landing of the freight, the controller is configured to release the supported state of the freight supported by the support tool.
